(19) United States
(12) Patent Application Publication
(10) Pub. No.: US 2020/0376800 A1
(43) Pub. Date: Dec. 3, 2020

(54) GAS-PERMEABLE PLANAR STRUCTURE

(71) Applicant: TESA SE, Norderstedt (DE)

(72) Inventor: Hannes DAG, Hamburg (DE)

(21) Appl. No.: 16/305,710

(22) PCT Filed: May 31, 2017
(86) PCT No.: PCT/EP2017/063150

§ 371 Date: Nov. 29, 2018

(30) Foreign Application Priority Data
Jun. 2, 2016 (DE) 10 2016 209 729.6

(51) Int. Cl. B32B 5/32; B32B 3/30; B32B 7/04; B32B 5/18

(52) U.S. Cl. CPC B32B 5/32; B32B 3/30; B32B 7/04; B32B 5/18; B32B 2266/025; B32B 2266/0242; B32B 2419/00; B32B 2266/08; B32B 2266/06; B32B 2307/56; B32B 2307/724; B32B 2405/00; B32B 2266/0278

(57) ABSTRACT

The aim of the invention is to provide polymeric planar structures having good gas permeability, wherein a high variability with regard to the product design is made possible. This aim is achieved by means of a planar structure that comprises at least two directly successive layers, wherein the two directly successive layers are each independently from another a polymer foam or a film. At least one of the two directly successive layers has channels in the surface thereof facing the other layer, which extend from one of the edges bounding the interface plane formed by the two successive layers to another of these edges such that the channels have a free volume sufficient for vapor permeability. The invention further relates to a method for producing planar structures according to the invention, and to the use thereof.

The invention is situated in the technical field of the polymeric sheetlike structures of the kind used, for example, as adhesive bonding materials or else simply as auxiliary materials in constructional applications. A specific application of the invention is situated in the field of spacers, especially of foamed spacers, in the installation of glass elements into frames intended for them. Sheetlike structures, more particularly foams, having improved gas and/or vapor permeability are proposed.

It is frequently necessary for polymer materials used as sheetlike structures to be equipped with a certain permeability for gases. This is relevant, for example, in applications of foamed sheetlike structures as carriers in single-sided or double-sided adhesive tapes or as spacers in the adhesive bonding of window glass to the corresponding frame elements. In the latter adhesive bonds, adhesives are frequently utilized that have to react with moisture in order to be able to cure. If, then, a foamed sheetlike element is used as a spacer in order to provide preliminary fixing of the glass element in the frame, the spacer must be sufficiently permeable to water vapor in order to enable atmospheric moisture to migrate to the silicone adhesives widely employed in these applications. The silicone adhesives generally require the atmospheric moisture in order to be able to crosslink speedily and reliably.

A foamed tape which finds use in the installation of glass elements in frame constructions is described in U.S. Pat. No. 8,826,611 B2, for example.

Whereas the gas permeability of films is determined generally by their material and their thickness, a significant codeterminant thereof in the case of foams is their cell structure. In the case of open-cell foams, permeability is frequently sufficient. Closed-cell foams, in contrast, generally have very little permeability for gases, or none. With such foams, transport of the gas through dense polymer material is necessary, and can be accomplished only through very slow processes such as diffusion, for example. Accordingly, closed-cell foams are frequently used for sealing applications.

Such applications more involving sealing are described in WO 2013/029871 A1, for example.

An interlayer for laminated glass that has very good venting qualities in the production of glass laminates and consists of two or more layers laminated together is subject-matter of US 2016/0101602 A1.

In general there is an ongoing demand for polymeric sheetlike structures having good gas permeability. It is an object of the invention, therefore, to provide sheetlike structures of this kind, the aim being to enable high variability in terms of the product design (thickness, density, etc.). In particular it is to be possible to achieve high gas permeability even for closed-cell foams.

The solution to the problem is based on the idea of using two-layer constructions having a specific structuring. A first and general subject of the invention is a sheetlike structure which comprises at least two directly successive layers, where the two directly successive layers independently of one another are each a polymer foam or a film and at least one of the two directly successive layers, in its surface facing the other layer, has channels which reach from one to another of the edges bounding the interfacial plane formed by the two successive layers, such that the channels have a free volume sufficient for vapor permeability.

A subject of the invention more particularly is a sheetlike structure which comprises at least two directly successive layers, where the two directly successive layers independently of one another are each a polymer foam or a film and at least one of the two directly successive layers, in its surface facing the other layer, has channels which reach from one to the other of the edges bounding, parallel to the longitudinal direction or machine direction, the interfacial plane formed by the two successive layers, such that the channels have a free volume sufficient for vapor permeability.

The sheetlike structure of the invention enables a structural solution to the problem of gas permeability by locating channels intended for that purpose within the polymeric structure. The consequence of this is that both the material and the rest of the construction of the sheetlike structure can be selected largely independently of the gas permeability, thus allowing the sheetlike structure to be designed very variably and optimized with regard to the desired function.

A “sheetlike structure” comprehends an areal arrangement of a system whose dimensions in one spatial direction (namely the thickness or the height) are significantly smaller than at least in one of the two other spatial directions that define the principal extent (length and width), but in particular than in both the other spatial directions. The sheetlike structure of the invention comprises at least two directly successive layers. “Directly successive” here means that the two layers adjoin one another directly in the construction of the sheetlike structure, and in particular that there is no further layer disposed between these two layers.

The two directly successive layers are independently of one another each a polymer foam or a film.

A foam comprehends a material having open and/or closed cells distributed over its entire mass and having an apparent density lower than that of the framework material. The expression “foam” means in particular that the layer in question comprises structures composed of gas-filled, frequently spherical or polyhedral cells which are bounded by liquid, semiliquid, relatively high-viscosity or solid cell struts or by an endogenous shell material and which are present in the layer in question in a proportion such that the density of the foamed layer is reduced in relation to the density of the matrix material—that is, the entirety of the nongaseous materials apart from any endogenous shell material present in the foam cells—from which the layer in question is constructed.

When a foam is formed it is common for there to be superficial, thin skin layers formed in which there are only a few foam cells or none at all. These process-related layers are not considered in accordance with the invention to be separate layers, but are assigned to the relevant foam or relevant foamed layer. Similarly, thin unfoamed layers of the matrix material of a foam layer delivered by coextrusion together with these layers are considered to belong to the foam layer, and not as a separate layer.

The framework substance, also referred to below as polymer foam matrix, foam matrix, matrix, or matrix material, in accordance with the invention comprises one or more polymers, which may have been blended with adjuvants. “Open cells” are voids within the foam that are not completely surrounded by framework material or endogenous shell material. “Closed cells” are voids which are entirely surrounded by framework material or endogenous shell material. Open cells therefore frequently lead to the development of channel networks within the foam, through which a certain level of gas transport may be possible.

In the case of polyurethane foams, the cell structure is reflected in the hardness of the material. Open-cell polyurethane foams are generally flexible, while their closed-cell counterparts are rigid. For the transitional region or corresponding hybrid forms, the term “semirigid” has been coined.

The matrix material of the polymer foam preferably comprises one or more polymers to an extent of at least 30 wt %, more preferably at least 50 wt %, and very preferably at least 70 wt %, more particularly at least 90 wt %, based in each case on the total weight of the polymer foam. Possible polymers of the matrix material include polyolefins, examples being polyethylenes such as high density polyethylene (HDPE), low density polyethylene (LDPE), linear low density polyethylene (LLDPE) and linear ultra low density polyethylene, polypropylene, and polybutylene; vinyl copolymers, e.g., polyvinyl chloride and polyvinyl acetate; olefinic random or block copolymers, examples being ethylene methylacrylate copolymers, ethylene-vinyl acetate copolymers, and ethylene-propylene copolymers, and also polyalkylenes prepared from monomer mixtures which comprise 1) a first alkene, selected from ethylene, propylene or a mixture thereof, and 2) a second alkene, selected from 1,2-alkenes having 4 to 8 carbon atoms such as 1,2-butene, 1,2-hexene or 1,2-octene; acrylonitrile-butadiene-styrene copolymers; acrylic polymers and copolymers, e.g. polymethacrylimides and polymethyl methacrylates; polycarbonates, polyimides, polyurethanes, thermoplastic polyurethanes for example, more particularly polyester-based thermoplastic polyurethanes; polyesters, e.g., polyethylene terephthalate; and also combinations and blends of the aforesaid polymers. Exemplary blends include polypropylene-polyethylene blends, polyurethane-polyolefin blends, polyurethane-polycarbonate blends, and polyurethane-polyester blends. Blends may further be comprised of thermoplastic polymers, elastomeric polymers, and combinations thereof. Other blends may be styrene-butadiene copolymers, polychloroprenes, e.g., neoprene, nitrile rubbers, butyl rubbers, polysulfide rubbers, cis-1,4-polyisoprene, ethylene-propylene terpolymers, e.g., EPDM rubber, silicone rubbers, silicone-polyurea block copolymers, polyurethane rubbers, natural rubbers, acrylate rubbers, thermoplastic rubbers, examples being styrene-butadiene block copolymers, styrene-isoprene-styrene block copolymers, styrene-ethylene/butylene-styrene block copolymers, styrene-ethylene/propylene-styrene block copolymers, thermoplastic polyolefin rubbers, and combinations thereof.

The polymers of the matrix material are preferably selected from the group consisting of polyolefins; polyurethanes; polyvinyl chloride (PVC); terpolymers of ethylene, propylene, and a nonconjugated diene (EPDM); copolymers of ethylene and an ethylene substituted by a polar group; blends of polyethylene and a polymer composed of an ethylene substituted by a polar group; poly(meth)acrylates; blends of poly(meth)acrylate and synthetic rubber, and also mixtures of two or more of the aforesaid polymers. The matrix material of the polymer foam therefore comprises preferably at least 30 wt %, more preferably at least 50 wt %, and very preferably at least 70 wt %, more particularly at least 90 wt %, based in each case on the total weight of the matrix material, of one or more polymers selected from the group consisting of polyolefins; polyurethanes; polyvinyl chloride (PVC); terpolymers of ethylene, propylene, and a nonconjugated diene (EPDM); copolymers of ethylene and an ethylene substituted by a polar group; blends of polyethylene and a polymer composed of an ethylene substituted by a polar group; poly(meth)acrylates; blends of poly(meth)acrylate and synthetic rubber, and also mixtures of two or more of the aforesaid polymers. With particular preference the matrix material contains no polymers other than one or more polymers selected from the group consisting of polyolefins; polyurethanes; polyvinyl chloride (PVC); terpolymers of ethylene, propylene, and a nonconjugated diene (EPDM); copolymers of ethylene and an ethylene substituted by a polar group; blends of polyethylene and a polymer composed of an ethylene substituted by a polar group; poly(meth)acrylates; blends of poly(meth)acrylate and synthetic rubber, and also mixtures of two or more of the aforesaid polymers.

With preference in accordance with the invention the polymer basis of the matrix material of the polymer foam is selected from the group consisting of polyethylenes, copolymers of ethylene and a 1,2-olefin having 4 to 8 carbon atoms, ethylene-vinyl acetate copolymers, blends of polyethylene and an ethylene-vinyl acetate copolymer, poly(meth)acrylates, and blends of poly(meth)acrylate and synthetic rubber. By “polymer basis” is meant the polymer or the class of polymer that has the greatest proportion by mass among the entirety of the polymers present in the framework material of the foam.

With particular preference the matrix material of the polymer foam comprises at least one polymer selected from polyolefins and copolymers of ethylene and an ethylene substituted by a polar group. In particular, the proportion of the entirety of all polymers selected from polyolefins and copolymers of ethylene and an ethylene substituted by a polar group within the matrix material of the polymer foam is at least 30 wt %, more preferably at least 50 wt %, and very preferably at least 70 wt %, more particularly at least 80 wt %, as for example at least 90 wt %, based in each case on the total weight of the matrix material. With very particular preference the matrix material contains no polymers other than one or more polymers selected from polyolefins and copolymers of ethylene and an ethylene substituted by a polar group.

With particular preference the matrix material of the polymer foam comprises at least one copolymer of ethylene and an ethylene substituted by a polar group. In particular, the proportion of the entirety of all copolymers of ethylene and an ethylene substituted by a polar group within the matrix material of the polymer foam is at least 30 wt %, more preferably at least 50 wt %, and very preferably at least 70 wt %, more particularly at least 80 wt %, as for example at least 90 wt %, based in each case on the total weight of the matrix material. With very particular preference the matrix material contains no polymers other than one or more copolymers of ethylene and an ethylene substituted by a polar group.

A “polyolefin” in accordance with the invention refers to a polymer of the general structure —[CH₂—CR¹R²—]ₙ—, in which R¹ and R² independently of one another denote a hydrogen atom or a linear or branched, saturated aliphatic or cycloaliphatic group. The polyolefin is preferably polyethylene, polypropylene, polybutylene or a mixture of these. The polyethylene in this case may be one or more of the conventional polyethylene types such as HDPE, LDPE, LLDPE, VLDPE, VLLDPE, MDPE (medium-density PE), metallocene PE types such as mLLDPE and mHDPE, blends of these polyethylene types, and mixtures thereof. The polypropylene is preferably a crystalline polypropylene, more preferably a homopolypropylene (hPP). In one specific embodiment of the invention, the polymer foam contains no polymers other than one or more polyolefins.

A copolymer of ethylene and an ethylene substituted by a polar group is understood to be a polymer of the general structure —[CH₂—CR³R⁴—]ₙ— in which R³ or R⁴ denote a hydrogen atom and the remaining substituent denotes a group containing at least one oxygen atom. The copolymer of ethylene and an ethylene substituted by a polar group is preferably an ethylene-vinyl acetate copolymer (EVA), an ethylene-methyl acrylate copolymer (EMA), an ethylene-ethyl acrylate copolymer (EEA), an ethylene-acrylic acid copolymer (EAA), an ethylene-butyl acrylate copolymer (EBA) or a mixture of these. The EVA preferably has a vinyl acetate content of 1 to 70 wt %, more preferably of 3 to 30 wt %, more particularly of 5 to 20 wt %. In one specific embodiment of the invention, the foamed layer contains no polymers other than one or more copolymers of ethylene and an ethylene substituted by a polar group.

In particular, the copolymer of ethylene and an ethylene substituted by a polar group is an ethylene-vinyl acetate copolymer (EVA).

With particular preference, therefore, the matrix material of the polymer foam comprises at least one ethylene-vinyl acetate copolymer (EVA). In particular, the proportion of the entirety of all ethylene-vinyl acetate copolymers in the matrix material of the polymer foam is at least 30 wt %, more preferably at least 50 wt %, and very preferably at least 70 wt %, more particularly at least 80 wt %, as for example at least 90 wt %, based in each case on the total weight of the matrix material. With very particular preference the matrix material contains no polymers other than one or more ethylene-vinyl acetate copolymers (EVA).

The matrix material of the polymer foam is preferably crosslinked. The crosslinking takes place preferably before the foaming of the matrix material. Matrix materials which comprise polymers selected from polyolefins and copolymers of ethylene and an ethylene substituted by a polar group are crosslinked preferably with electron beams. Also suitable are chemical crosslinking methods, an example being crosslinking via grafted-on silane radicals with hydrolyzable groups, which are then able to react with one another under the influence of moisture and catalysis; additionally, crosslinking via added silanes which contain a radically polymerizable double bond and are able to react with radicals formed in the polymer chains; and also crosslinking via added peroxides, which likewise react with radicals.

At least one of the two directly successive layers of the sheetlike structure of the invention is preferably a polymer foam. For applications with a requirement for “gas permeability” as well, the invention in this case allows the advantages of foams in terms of a reduction in weight of material to be exploited. Likewise preferably, at least one of the two directly successive layers of the sheetlike structure of the invention is a polymer foam, and the polymer foam is a closed-cell foam. In accordance with what has already been said, a “closed-cell foam” is a foam in which substantially all of the voids (cells) are surrounded entirely by framework material, hence in particular ruling out the possibility of channel networks forming within the foam and allowing gas transport through the layer. A closed-cell foam has in general only very little permeability for gases and vapors. The reason for this is presumably that the gas molecules are required to penetrate dense polymer material of the cell walls and cell struts and are therefore able to diffuse only very slowly through the foam. With particular preference, at least one of the two directly successive layers is a polymer foam, and this polymer foam has the channels.

With particular preference, both directly successive layers independently of one another are each a polymer foam. The polymer foams of the two layers in this case may be identical or different from one another. Similarly, the polymer foams of the two layers may be chemically and/or physically identical but differ from one another in their dimensions, such as in the thickness of the layer in question, for example. With very particular preference both directly successive layers independently of one another are each a polymer foam, and only one of the two directly successive layers has the channels. Likewise with very particular preference, both directly successive layers independently of one another are each a closed-cell polymer foam.

The thickness of the sheetlike structure of the invention in which the two directly successive layers independently of one another are each a polymer foam is preferably 50 μm to 20 mm, more preferably 800 μm to 15 mm, more particularly 2 to 13 mm.

In the embodiment with two closed-cell polymer foams as directly successive layers, in particular, the sheetlike structure of the invention enables a closed-cell foam system which one- or two-dimensionally according to design, along the boundary face between the two directly successive layers, has a gas permeability which may easily be well above the level of an open-cell foam structure. The transport of the gas molecules in this case need not take place through densified polymer material, but may take place simply via continuously polymer-free channel networks.

The foaming of the polymer foam matrix material may in principle have been brought about in any customary way, as for example by an added propellant gas or by a chemical foaming agent which at a certain temperature during processing decomposes and forms gas as it does so.

Another suitable method of foaming is the incorporation of microballoons into the polymer foam matrix material. “Microballoons” are understood to mean hollow microspheres which are elastic and hence expandable in their ground state, with a thermoplastic polymer shell. These spheres are filled with low-boiling liquids or liquefied gas. Shell material used includes, in particular, polyacrylonitrile, PVDC, PVC or polyacrylates. Customary low-boiling liquid comprises, in particular, hydrocarbons of the lower alkanes, as for example isobutane or isopentane, which are enclosed under pressure in the polymer shell, in the form of liquefied gas.

Action on the microballoons, particularly by exposure to heat, causes the outer polymer shell to soften. At the same time, the liquid propellant gas within the shell is converted to its gaseous state. The microballoons in this case extend out irreversibly and undergo three-dimensional expansion. Expansion is at an end when the internal and external pressures are balanced. Since the polymeric shell is conserved, the result is then a closed-cell foam.

A host of microballoon types are available commercially, and differ essentially in terms of their size (6 to 45 μm diameter in the unexpanded state) and in the starting temperatures that they require for expansion (75 to 220° C.). Unexpanded microballoon types are also available in the form of an aqueous dispersion having a solids fraction or microballoon fraction of around 40 to 45 wt %, and additionally in the form of polymer-bound microballoons (masterbatches) as well, as for example in ethylene-vinyl acetate with a microballoon concentration of around 65 wt %. Not only the microballoon dispersions but also the masterbatches, like the unexpanded microballoons, are suitable as such for producing polymer foams of the invention.

Polymer foams of the invention may also be generated with what are called preexpanded microballoons. In this group, the expansion takes place prior to incorporation into the polymer matrix.

Polymer foams of the invention may also be generated using foamed particles; that is, with expanded or expandable beads of, in particular, polystyrene, polypropylene, thermoplastic polyurethane or cellulose acetate. Accordingly, particles of plastics which per se have already undergone foaming are incorporated into the polymer matrix, and produce the reduction in density. The particles may also be put unfoamed into the polymer matrix and only then be foamed. Furthermore, the polymer foam may also consist of optionally preexpanded “beads” joined to one another thermally, more particularly fused together, so that in this case there is no other surrounding matrix.

The density of a polymer foam of the invention is preferably less than 500 kg/m³, more preferably less than 350 kg/m³, more particularly from 90 to 250 kg/m³.

A “film” refers to a sheetlike, flexible, windable web whose material basis is formed in general by one or more polymers. Possible polymers of a film of the invention include polyolefins, examples being polyethylenes such as high density polyethylene (HDPE), low density polyethylene (LDPE), linear low density polyethylene (LLDPE) and linear ultra low density polyethylene, polypropylene, and polybutylene; vinyl copolymers, e.g., polyvinyl chloride and polyvinyl acetate; olefinic copolymers, examples being ethylene methylacrylate copolymers, ethylene-vinyl acetate copolymers, and ethylene-propylene copolymers; acrylonitrile-butadiene-styrene copolymers; acrylic polymers and copolymers, polycarbonates, polyurethanes, synthetic rubbers and also combinations and blends of the aforesaid polymers. Exemplary blends include polypropylene-polyethylene blends, polyurethane-polyolefin blends, polyurethane-polycarbonate blends, and polyurethane-polyester blends. Blends may further be comprised of thermoplastic polymers, elastomeric polymers, and combinations thereof. Other blends may be styrene-butadiene copolymers, polychloroprenes, e.g., neoprene, nitrile rubbers, butyl rubbers, polysulfide rubbers, cis-1,4-polyisoprene, ethylene-propylene terpolymers, e.g., EPDM rubber, silicone rubbers, silicone-polyurea block copolymers, polyurethane rubbers, natural rubbers, acrylate rubbers, thermoplastic rubbers, examples being styrene-butadiene block copolymers, styrene-isoprene-styrene block copolymers, styrene-ethylene/butylene-styrene block copolymers, styrene-ethylene/propylene-styrene block copolymers, thermoplastic polyolefin rubbers, and combinations thereof.

The polymer basis of a film of the invention is preferably selected from the group consisting of polyvinyl chloride (PVC), polyethylene terephthalate (PET), polyurethanes, polyolefins, polybutylene terephthalate (PBT), polycarbonates, polymethyl methacrylate (PMMA), polyvinyl butyral (PVB), synthetic rubbers, ionomers, and mixtures of two or more of the above-recited polymers. With particular preference the polymer basis of the film is selected from the group consisting of polyvinyl chloride, polyethylene terephthalate, polyurethanes, polyolefins, and mixtures of two or more of the above-recited polymers.

By “polyurethanes” are meant, in a broad sense, polymeric substances in which repeating units are linked to one another by urethane moieties —NH—CO—O—. The polyurethanes are preferably thermoplastic polyurethanes; more particularly polyester-based thermoplastic polyurethanes, based on aliphatic and/or aromatic polyesters; for example, thermoplastic polyurethanes terminated with hydroxy-aromatics. The polyurethanes may of course be linked to one another by crosslinkers, examples being isocyanate crosslinkers.

The synthetic rubbers encompass, in particular, AB and ABA block copolymers, and also star and radical block copolymers. The synthetic rubbers very preferably are elastomeric block copolymers with a rubberlike middle block and end blocks of high glass transition temperature. Suitable synthetic rubbers include, for example, types with unsaturated rubberlike fraction such as styrene-butadiene-styrene (SBS) and styrene-isoprene-styrene (SIS) block copolymers; likewise encompassed are types with saturated olefin rubber middle block, examples being styrene-ethylene-butadiene-styrene (SEBS) and styrene-ethylene-propylene-styrene (SEPS) block copolymers.

With preference the polymer basis of the film consists of one or more polyolefins. The polyolefins comprise, with particular preference, polyethylenes, polypropylenes, olefin copolymers, and blends of the aforesaid polymers. Preferred polyethylene types are, for example, polyethylenes of ultra high molar mass (UHMWPE), high density polyethylene (HDPE), low polyethylene (LDPE), linear low density polyethylene (LLDPE), and linear ultra low density polyethylene. With particular preference the polymer basis of the film consists of one or more high density polyethylenes (HDPE). Preferred polypropylene types are homopolymeric polypropylene (h-PP) and impact-PP. Preferred olefin copolymers are ethylene-propylene copolymers, more particularly random ethylene-propylene copolymers (r-PP), and also terpolymers of ethylene, propylene, and a nonconjugated diene (EPDM rubbers); and also polyolefins prepared from monomer mixtures which comprise 1) a first alkene, selected from ethylene, propylene or a mixture thereof, and 2) a second alkene, selected from 1-2-alkenes having 4 to 8 carbon atoms such as 1,2-butene, 1,2-hexene or 1,2-octene. Blends of the aforesaid polyolefins are likewise preferred base materials of the film. Preferred blends are polypropylene-polyethylene blends.

In accordance with the invention, at least one of the two directly successive layers, in its surface facing the other layer, has channels which reach from one to another of the edges bounding the interfacial plane formed by the two successive layers, such that the channels have a free volume sufficient for vapor permeability.

A channel in accordance with the invention is a recess which begins in the surface of the film or the polymer foam, is deliberately introduced, has dimensions exceeding that of the molecular range, exists within the film or the polymer foam, and fundamentally may have any desired shape and depth, as long as it provides a free volume sufficient for gas permeability. The recess in principle does not extend to the base of the film or polymer foam in question; in other words, at its base there is still film or foam material present. The shape of the channels is in principle not critical; it may be guided, for example, by a rectangular to U-shaped cross section.

The gas permeability of the sheetlike structure of the invention is preferably less than 0.05 m, more preferably less than 0.03 m, in each case as equivalent air layer thickness (sd) in accordance with DIN EN ISO 12572 at a specimen layer thickness of 1 mm. The gas permeability of the sheetlike structure of the invention is therefore preferably high enough to give an equivalent air layer thickness (sd) in accordance with DIN EN ISO 12572 for a specimen layer thickness of 1 mm of less than 0.05 m, more preferably of less than 0.03 m.

Where a polymer foam has the channels, the width of these is preferably from 0.5 to 10 mm, more preferably from 0.8 to 5 mm, very preferably from 1 to 3 mm. If a film has the channels, the width of these is preferably from 10 to 150 μm, more preferably from 15 to 130 μm, more particularly from 20 to 120 μm.

Where a polymer foam has the channels, the depth of these is preferably from 0.1 to 2 mm, more preferably from 0.3 to 1.5 mm, very preferably from 0.5 to 1.3 mm. Where a film has the channels, the depth of these is preferably from 7 to 25 μm, more preferably from 10 to 20 μm.

Where a polymer foam has the channels, the lateral spacing of these from one another is preferably from 2 to 10 mm, more preferably from 4 to 8 mm, very preferably from 5 to 7 mm. Where a film has the channels, the lateral spacing of these from one another is preferably from 20 to 1000 μm. The lateral spacing corresponds to the spacing of a defined point within the channel structure from the corresponding point within the structure of the most closely adjacent channel.

The proportion of the cross-sectional area of the channels present in accordance with the invention within the cross-sectional area, resulting from the same section, of the film or polymer foam containing these channels is preferably 0.3% to 30%, more preferably 1% to 25%, more particularly 4% to 11%. The cross-sectional area in the above sense is regarded as an area formed by a section in the plane generated by the z-direction and the direction running at a right angle transversely to the orientation of the channels, at any desired point on the sheetlike structure of the invention. The proportion of the cross-sectional area of the channels present in accordance with the invention within the cross-sectional area, resulting from the same section, of the polymer foam containing these channels varies preferably as a function of the thickness of the polymer foam or polymer foam layer. Hence for a foam thickness of 2 to 4 mm, the aforementioned proportion is preferably 8% to 14%; for a foam thickness of more than 4 to 6 mm it is preferably 6% to less than 8%; for a foam thickness of more than 6 to 8 mm it is preferably 4.5% to less than 6%; and for a foam thickness of more than 8 to 9 mm it is preferably 2% to less than 4.5%.

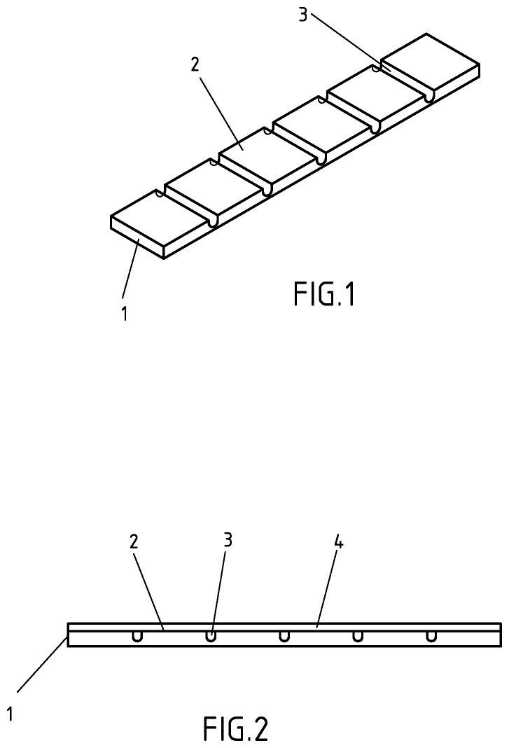

The construction of a sheetlike structure of the invention is also intended to be illustrated by FIGS. 1 and 2. FIG. 1 shows a channel-comprising layer of the sheetlike structure of the invention, without the second layer that is in contact with this layer. FIG. 2 shows a side view of a sheetlike structure of the invention, with a lower layer containing the channels, and with a top layer lying directly on the first layer. In both figures, the channels run at a right angle transversely to the machine direction; here, therefore, the above-described cross section would correspond to a section in the plane generated by the machine direction and the z-direction. The meanings of the reference numerals are as follows:
1—the channel-comprising layer of the sheetlike structure (polymer foam or film);
2—interface to the second layer of the sheetlike structure;
3—channel;
4—second layer of the sheetlike structure.

A sheetlike structure of the invention may be produced in a substantially two-stage operation, which may be continuous in form. A further subject of the invention is a method for producing a sheetlike structure of the invention, which comprises

a) the heating of at least one surface of a first web of a polymer foam or of a film,
b) impressing of channels into the heated surface of this web,
c) the providing of a second web of a polymer foam or of a film, and
d) the laminating of the two webs to one another such that the channel-containing surface of the first web enters into direct contact with one of the surfaces of the second web.

The impressing of the channels into the surface of one of the films or polymer foam layers is accomplished preferably by heating of the film or polymer foam to a point of thermal deformability and subsequently carrying out deformation in accordance with the surface structure of the impressing tool which acts on the surface under pressure. The impressing tool may be, for example, a die or a roll, which preferably are made of metal. Alternatively, the impressing tool may also be heated and may act on a cold foam or a cold film.

For the laminating of the two webs to one another, it may be necessary to heat at least that surface of the second web that is intended for contacting with the channel-comprising surface of the first web. In some cases, just the heat transferred from the heated surface of the first web is sufficient for this purpose; in other cases, the relevant surface of the second web must be heated separately. In one embodiment, therefore, the method of the invention additionally comprises the heating of at least one surface of the second web and the laminating of the two webs to one another in such a way that the two heated surfaces come into contact with one another.

The sheetlike structure of the invention may be used as a carrier for a single-sided or double-sided adhesive tape. In principle it is possible for one or both polymer foam layer(s) of the sheetlike structure of the invention to have pressure-sensitive adhesion, subject, of course, to the proviso that the sheetlike structure comprises at least one polymer foam layer. It is likewise possible for one or both sides of the sheetlike structure of the invention, on the principal faces, to bear a pressure-sensitive adhesive. The nature and/or configuration of this pressure-sensitive adhesive is fundamentally arbitrary; in principle, all known and available pressure-sensitive adhesives can be used. As is generally customary, the pressure-sensitive adhesives—especially if the adhesive tape is wound into a roll—may be protected with a release liner.

In order to anchor a pressure-sensitive adhesive on a polymer foam layer or else on a film of the sheetlike structure of the invention, it may be necessary to raise the surface energy of the foam, the film and/or the pressure-sensitive adhesive. For this purpose, the surfaces in question are preferably pretreated by means of physical methods such as corona, flame treatment, plasma and/or aerosol, or provided with a primer. For polyolefin foams in particular, corona treatment in a nitrogen atmosphere is preferably employed.

The sheetlike structure of the invention is used preferably, furthermore, as a spacer in structural glazing or curtain wall construction applications. Here, glazing elements or facing plates are bonded in particular with structural silicone adhesives in frame constructions. The spacer in such a system ensures the correct spacing between glass element or facing element and frame, and occasionally also serves as a barrier to liquid reactive silicone that is introduced. In general, the spacer also remains in the construction after the curing of the structural adhesive, but then no longer has any supporting function. For use as spacers, preferably at least one of the two directly successive layers of the sheetlike structure of the invention is a polymer foam, and more preferably both directly successive layers independently of one another are a polymer foam. The foams are preferably UV-stabilized. Likewise preferably, the foams have black or gray coloration. They preferably have a low thermal conductivity, this being beneficial to the U value of the overall glazing or facing element. As and when required, the spacers may be made electrically dissipatory or electrically conductive.

For powder-coated frame constructions, it may be advantageous if the sheetlike structure of the invention exhibits effective adhesion to low-energy surfaces. It is possible, furthermore, to pretreat the frame by means of cleaning, degreasing, abrading and/or priming.

Particularly as a constituent of adhesive tapes, the sheetlike structure may also find use in the assembly of electronic devices, in the form, for example, of gas-permeable “lens melting tape” in the assembly of smartphones. Particularly suitable for this purpose are the embodiments comprising at least one film.

Other preferred uses of the sheetlike structure of the invention are in building construction, particularly for ventilation, air release or pressure compensation, but also for conveying away water condensation and moisture in general, such as in wooden floor constructions, for example; in vehicle construction, as for example in automaking and in production of trains, more particularly here for sound and heat insulation in conjunction with an air admittance function; in aircraft construction, as for example for the heating or cooling of sandwich constructions to maintain the foam core at an optimum temperature; in cooling systems (refrigerators, air-conditioning units) as an insulation layer through which a cooling medium can flow; in general, as buffers, impact absorbers or dampers with additional air admittance and/or air removal function in diverse applications, and also in stretch-releasable spacer foam tapes.

### EXAMPLES

Sheetlike structures were formed each from two polymer foam layers joined to one another, of which one in each case was provided with channels. The assembly was produced such that the channels faced the second polymer foam layer. The polymer foam layers used were commercially available foams which are indicated in the table below.

Regarding the Production Procedure in Detail:

Impressing of the Channels:

The channels were generated using an impression tool made of anodized aluminum. This was done by first heating the foam until it was thermally deformable. Sufficient deformability was reached after 20 seconds at 160° C. Only then was the cold impression tool pressed into the foam. During this impression procedure of 60 seconds, the foam lost its thermoformability and the impressed negative, accordingly, remained dimensionally stable. The impression operation took place under a pressure of 20 kPa; the maximum impressed depth was limited at the same time by machine limits/spacers. All of the channels were impressed in such a way that they ran at a right angle transversely to the machine direction (corresponding to FIGS. 1 and 2).

Joining of the Layers to One Another:

The polymer foam layers were joined to one another via thermal welding. For this purpose, the surface of one of the layers to be joined was brought into a sealable state by using a hot air stream with a temperature of around 200° C. to heat a thin, near-surface layer of this foam. The duration of this treatment was a few seconds, and immediately preceded the application of the second foam ply. Rolling over the assembly under gentle pressure then ensured that all of the contact areas fused to one another.

TABLE 1
examples

| | | | | | | | | | Water vapor |
|---|---|---|---|---|---|---|---|---|---|
| | | | | | | Compressive | | | permeability |
| | | | | | | strength | | | (as equivalent |
| | | | | | | at 10% | | | air layer |
| | | | | | Density | compression | Thick- | | thickness |
| | | | | | (Product) | ASTM D1621 - | ness | Area | sd_{(1 mm)}) |
| | | | Matrix | Cell | DIN EN | 10 (2.5 mm/ | ISO | fraction | to DIN EN |
| | | Tradename | polymer | structure | ISO 845 | min) | 1923 | (channels)* | ISO 12572 |
| No. | Manufacturer | of foams | of foams | of foams | [kg/m³] | [kPA] | [mm] | [%] | [m] |
| 1 | SEKISUI | TEE SR 0401.48 | polyolefin | closed- | 274 | 210 | 3.0 | 11 | 0.01 |
| | ALVEO AG | with channels + | | cell | | | | | |
| | | TEE SR 0401.48 | | | | | | | |
| 2 | SEKISUI | TEE SR 0401.48 | polyolefin | closed- | 208 | 147 | 4.5 | 7 | 0.01 |
| | ALVEO AG | with channels + | | cell | | | | | |
| | | TEE HD SR 0503 | | | | | | | |
| 3 | SEKISUI | TEE SR 0401.48 | polyolefin | closed- | 129 | 123 | 8.5 | 4 | 0.03 |
| | ALVEO AG | with channels + | | cell | | | | | |
| | | NEE 0805.5 | | | | | | | |
| 4 | SEKISUI | TEE HD SR 0503 | polyolefin | closed- | 204 | 98 | 4.5 | 7 | 0.02 |
| | ALVEO AG | with channels + | | cell | | | | | |
| | | TEE SR 0401.48 | | | | | | | |
| 5 | SEKISUI | TEE HD SR 0503 | polyolefin | closed- | 175 | 105 | 6.0 | 5 | 0.02 |
| | ALVEO AG | with channels + | | cell | | | | | |
| | | TEE HD SR 0503 | | | | | | | |
| 6 | SEKISUI | TEE HD SR 0503 | polyolefin | closed- | 145 | 111 | 8.5 | 4 | 0.03 |
| | ALVEO AG | with channels + | | cell | | | | | |
| | | NEE 0805.5 | | | | | | | |
| 7 | Evonik | Rohacell 71 HF; | polymethacrylimide | closed- | 74 | 1050 | 6.0 | 5 | 0.02 |
| | Industries AG | 2 × 3 mm, one | | cell | | | | | |
| | | layer with channels | | | | | | | |
| 8 | BASF SE | Neopolen P | polypropylene | closed- | 69 | 336 | 6.0 | 5 | 0.02 |
| | | (70 kg/m³); | | cell | | | | | |
| | | | | (bead | | | | | |
| | | | | foam) | | | | | |
| | | 2 × 3 mm, one | | | | | | | |
| | | layer with channels | | | | | | | |
| 9 | Saint-Gobain | Thermalbond | polyurethane | open- | 352 | 110 | 6.4 | | 0.04 |
| | Corporation | V2200 | | cell | | | | | |
| | | | | (semi- | | | | | |
| | | | | rigid) | | | | | |
| 10 | tesa SE | 51955 | polyurethane | open- | 294 | 99 | 6.4 | | 0.13 |
| | | | | cell | | | | | |
| 11 | 3M | 2111 | polyurethane | open | 500 | 210 | 6.4 | | 0.05 |
| | Corporation | | | cell | | | | | |

*= (orthogonal section in longitudinal direction/MD)

1. A sheetlike structure comprising at least two directly successive layers, wherein
the two directly successive layers independently of one another are each a polymer foam or a film and
at least one of the two directly successive layers, in its surface facing the other layer, has channels which reach from one to another of the edges bounding the interfacial plane formed by the two successive layers, such that the channels have a free volume sufficient for vapor permeability.

2. The sheetlike structure as claimed in claim 1, wherein at least one of the two directly successive layers is a polymer foam.

3. The sheetlike structure as claimed in claim 2, wherein this polymer foam has the channels.

4. The sheetlike structure as claimed in claim 2, wherein the polymer foam is a closed-cell foam.

5. The sheetlike structure as claimed in claim 1, wherein both directly successive layers independently of one another are each a polymer foam.

6. The sheetlike structure as claimed in claim 5, wherein only one of the two directly successive layers has the channels.

7. The sheetlike structure as claimed in claim 1, wherein the polymer basis of the polymer foam is selected from the group consisting of polyethylenes, copolymers of ethylene and a 1,2-olefin having 4 to 8 carbon atoms, ethylene-vinyl acetate copolymers, blends of polyethylene and an ethylene-vinyl acetate copolymer, poly(meth)acrylates, and blends of poly(meth)acrylate and synthetic rubber.

8. A method for producing a sheetlike structure as claimed in claim 1, comprising
a) heating at least one surface of a first web of a polymer foam or of a film,
b) impressing channels into the heated surface of this web,
c) providing a second web of a polymer foam or of a film, and
d) laminating the two webs to one another such that the channel-containing surface of the first web enters into direct contact with one of the surfaces of the second web.

9. A single-sided or double-sided adhesive tape comprising a carrier which is the sheetlike structure of claim 1.

10. A spacer in structural glazing or curtain wall construction applications, which is the sheetlike structure of claim 1.
